(19) United States
(12) Patent Application Publication
(10) Pub. No.: US 2004/0230614 A1
(43) Pub. Date: Nov. 18, 2004

(54) Data processing method and apparatus of same

(75) Inventor: Jun Hirai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/789,978

(22) Filed: Mar. 2, 2004

(30) Foreign Application Priority Data
Mar. 10, 2003 (JP) 2003-063269

(51) Int. Cl. G06F 7/00

(52) U.S. Cl. 707/104.1

(57) ABSTRACT

A data processing method enabling identification of a source of leakage of content data leaked from predetermined recording media, comprising playing back an object film to generate reproduction data, detecting correlation between identified content reproduced data and difference data read from a database in a correlation detection unit, deciding whether or not there is a difference caused by inherent variations in recording sensitivity on the basis of the correlation, and identifying from which of a plurality of legally copied films the object film was obtained from on the basis of the result of the decision.

### BACKGROUND OF THE INVENTION

1. Field of the Invention

The present invention relates to a data processing method for identifying a recording medium serving as a source of leakage of content data and an apparatus for the same.

2. Description of the Related Art

Content to be shown for example at movie theaters and the like is distributed by for example copying it from master content onto a plurality of films and distributing the films to the movie theaters. However, pirated copies of movies and other content are sometimes prepared by for example capturing content images shown at a movie theater by a camcorder and recording the same on a magnetic tape or the like. As a countermeasure against such pirated copies, for example, U.S. Pat. No. 6018374 discloses the technique of projecting the name of the movie theater which is invisible when a person watches the images shown on the screen of the movie theater, but is shown when captured by a camera.

Summarizing the problems to be solved by the invention, in the related art, if a movie theater conspires with a manufacturer of pirated copies and covers the device for projecting the name of the movie theater on the screen or adjusts the infrared filter of the camera to produce pirated copies on which the name of the movie theater is not shown, the source (movie theater) cannot be identified.

### SUMMARY OF THE INVENTION

An object of the present invention is to provide a data processing method for enabling identification of the source of leakage of content data leaked from predetermined recording media and an apparatus for the same.

To attain the above object, according to a first aspect of the invention, there is provided a data processing method for identifying whether or not a content data was obtained on the basis of a recording medium having inherent variations in recording sensitivity which is produced by recording a first content data, comprising: a first step of detecting correlation between a difference between the first content data and second content data obtained from the recording medium and third content data which is an object for inspection and a second step of deciding whether or not there is any common point derived from the inherent variations in the recording sensitivity between the second content data and the third content data on the basis of the correlation detected in the first step and identifying whether or not the third content data was obtained on the basis of the recording medium on the basis of a result of the decision.

The mode of operation of the data processing method of the first aspect of the invention is as follows: At the first step, the correlation between the difference between the first content data and second content data obtained from the recording medium and the third content data is detected. Next, at the second step, it is decided on the basis of the correlation extracted at the first step whether or not there is any common point derived from the inherent variation of the recording sensitivity between the second content data and the third content data and it is identified whether or not the third content data was obtained on the basis of the recording medium on the basis of the result of the decision.

The data processing method of the first aspect of the invention preferably further comprises a fourth step of capturing an image obtained from the predetermined recording medium to generate digital first content data; a fifth step of capturing an image obtained from the recording medium having the inherent variation to generated digital second content data; and a sixth step of capturing an image obtained from the object recording medium to generate digital third content data, wherein the first step detects correlation between a difference between the first content data generated at the fourth step and the second content data generated at the fifth step and the third content data generated at the sixth step.

According to a second aspect of the invention, there is provided a data processing apparatus for identifying whether or not a content data was obtained on the basis of a recording medium having inherent variations in recording sensitivity which is produced by recording a first content data, comprising: a correlation detecting means for detecting correlation between a difference between the first content data and second content data obtained from the recording medium and third content data which is an object for inspection and an identifying means for deciding whether or not there is any common point derived from the inherent variations in the recording sensitivity between the second content data and the third content data on the basis of the correlation detected by the correlation means and identifying whether or not the third content data was obtained on the basis of the recording medium on the basis of a result of the decision.

The mode of operation of the data processor of the second aspect of the invention becomes as follows: The correlation detecting means detects the correlation between the difference between the first content data and the second content data obtained from the recording medium and the third content data. Next, the identifying means decides whether or not there is any common point derived from the inherent variations in recording sensitivity between the second content data and the third content data on the basis of the correlation extracted by the correlation detecting means and identifies whether or not the third content data was obtained on the basis of the recording medium on the basis of the result of the decision.

According to a third aspect of the invention, there is provided a data processing apparatus for identifying whether or not a content data was obtained on the basis of a recording medium having inherent variations in recording sensitivity which is produced by recording a first content data, comprising: a correlation detecting circuit for detecting correlation between a difference between the first content data and second content data obtained from the recording medium and third content data which is an object for inspection and an identifying circuit for deciding whether or not there is any common point derived from the inherent variations in the recording sensitivity between the second content data and the third content data on the basis of the correlation detected by the correlation circuit and identifying whether or not the third content data was obtained on the basis of the recording medium on the basis of a result of the decision.

### BRIEF DESCRIPTION OF THE DRAWINGS

These and other objects and features of the present invention will become clearer from the following description of the preferred embodiments given with reference to the attached drawings, wherein:

FIG. 1 is a view of the configuration of a data processor according to a first embodiment of the present invention;

FIG. 2 is a flow chart for briefly explaining the processing routine of the data processor shown in FIG. 1;

FIG. 3 is a functional block diagram of a portion concerned with correlation detection of a correlation processing unit shown in FIG. 1;

FIGS. 4A and 4B are graphs for explaining the correlation detection shown in FIG. 3;

FIG. 5 is a view for explaining the flow of data in a case of registering a master film MF in the data processor shown in FIG. 1;

FIG. 6 is a flow chart for explaining an example of operation in the case shown in FIG. 5.

FIG. 7 is a view for explaining the flow of the data when registering a legally copied film CF in the data processor shown in FIG. 1.

FIG. 8 is a flow chart for explaining an example of operation of the case shown in FIG. 7.

FIG. 9 is a view for explaining the flow of the data when identifying the legally copied film CF which has become the source of leakage of the object film RF in the data processor shown in FIG. 1;

FIG. 10 is a flow chart for explaining an example of operation of the case shown in FIG. 9;

FIG. 11 is a view for explaining a data processor according to a second embodiment of the present invention; and

FIG. 12 is a view for explaining a data processor according to a third embodiment of the present invention.

### DESCRIPTION OF THE PREFERRED EMBODIMENTS

Below, an explanation will be given of data processor according to embodiments of the present invention. The data processor of the embodiments is used when for example making a plurality of legally copied films from a master film of the content of a movie and distributing them to movie theaters. Further, the data processor of the embodiments is used for identifying from which of the copied films an object film was produced. Note that, the master film and the copied films in the embodiments are recording media having inherent variations in recording sensitivity.

First Embodiment

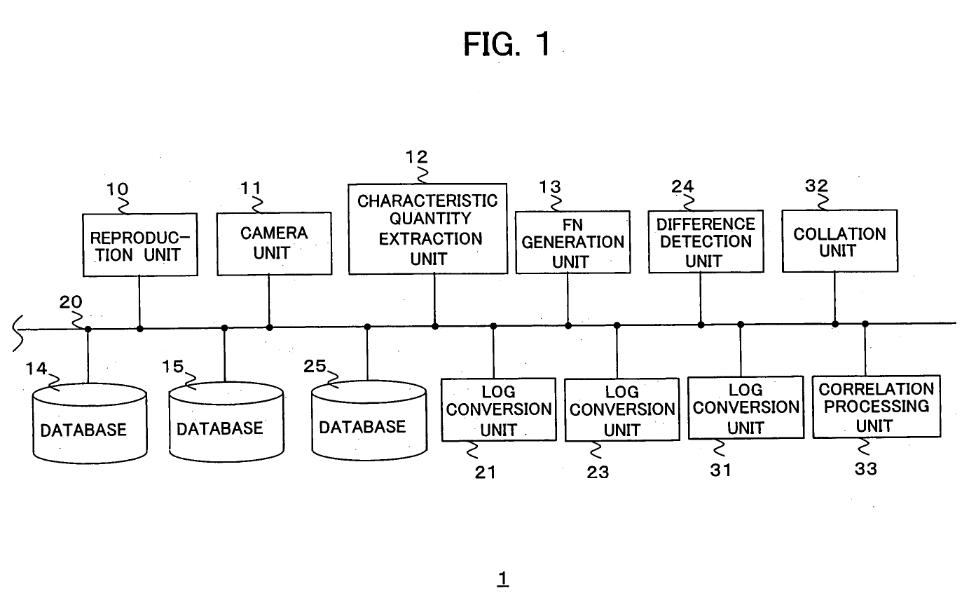

FIG. 1 is a view of the configuration of a data processor 1 according to a first embodiment of the present invention. As shown in FIG. 1, the data processor 1 has, for example, a reproduction unit 10, a camera unit 11, a characteristic extraction unit 12, an FN generation unit 13, a database 14, a database 15, a log conversion unit 21, a log conversion unit 23, a difference detection unit 24, a database 25, a log conversion unit 31, a collation unit 32, and a correlation processing unit 33. Here, the correlation processing unit 33 corresponds to the correlation detecting means and the identifying means of the present invention.

The components of the data processor 1 shown in FIG. 1 may be realized by circuits or computer programs.

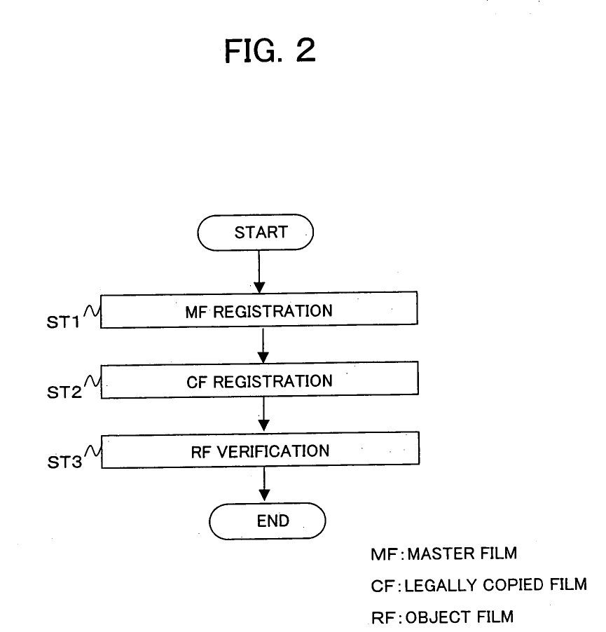

FIG. 2 is a flow chart for briefly explaining the processing routine of the data processor 1 shown in FIG. 1.

Step ST1:

The data processor 1 plays back for example the master film MF of the content of the movie, captures an image thereof by the camera unit 11, and records digital master content data MCD (first content data of the present invention) in the database 14.

Step ST2:

The data processor 1 plays back each of the plurality of legally copied films produced from the master film MF (hereinafter also referred to as “the legally copied films”, that is, the recording media of the present invention) and captures an image at the camera unit 11 to generate digital copied content data CCD (second content data of the present invention). Then, the difference detection unit 24 generates difference data DIF between the copied content data CCD and the master content data MCD for each copied film and records this in the database 25.

Step ST3:

The data processor 1 generates reproduction data RPCA (third content data of the present invention) from the film which is an object for inspection (that is, object film). Then, the data processor 1 detects the correlation between the reproduction data RPCA and the difference data DIF read from the database 25 at the correlation processing unit 33, decides whether or not there is any common point derived from the inherent variations in the recording sensitivity on the basis of the correlation, and identifies from which of the plurality of legally copied films the film was obtained. Note that the inherent variations in the recording sensitivity occur in the production process of the film (recording medium). Artificial reproduction is difficult.

Below, an explanation will be given of components shown in FIG. 1.

Reproduction Unit 10:

The reproduction unit 10 plays back the master film MF, the legally copied films CF, and the object film RF.

Camera Unit 11:

The camera unit 11 is for example a scanner (telecine) using an area sensor or a line sensor and captures an image obtained by the playback operation of the reproduction unit 10 to generate the digital content data.

Characteristic Extraction Unit 12:

The characteristic extraction unit 12 extracts characteristic quantities of the master content data MCD and the identified content data RPCA. The characteristic quantity is for example the mean brightness of a center portion of the image generated by the content data or other brightness information or the color saturation, hue, or other information concerning a histogram. Further, as the characteristic quantity, it is also possible to use one for identifying a frame around a characteristic point of change of the video. The characteristic quantity is used f6r realizing frame synchronization at the time of correlation detection between the object content data (content data which is an object for inspection) and the difference data.

FN Generation Unit 13:

The FN generation unit 13 generates frame number data NF on the basis of signals obtained in the playback operation of the film in the reproduction unit 10.

Database 14:

The database 14 stores the frame data MFL whose characteristic quantity was extracted in the digital master content data MCD and the frame number data FN thereof linked together by the operation of step ST1 shown in FIG. 2.

Database 15:

The database 15 records characteristic quantity data MRA indicating the characteristic quantity, the frame number data FN, and the identification data CID of the content of the master film MF linked together by the operation of step ST1 shown in FIG. 2.

Log Conversion Unit 21:

The log conversion unit 21 logarithmically converts the copied content data CCD to generate the copied content data CT. In the present embodiment, the log conversion is carried out so that a difference derived from noise is suitably generated in the difference processing in the later difference detection unit 24 since noise (grain noise) of the film occurs due to variations in the recording sensitivity and exist as a product of the brightness data (signals). Note that, it is not always necessary to perform the log conversion.

Logarithm Conversion Unit 23:

The log conversion unit 23 logarithmically converts the frame data MFL of the master content data to generate the frame data MT.

Difference Detection Unit 24:

The difference detection unit 24 generates difference data DIF indicating the difference between the copied content data CT and the frame data MT.

Database 25:

The database 25 records the difference data DIF, the frame number data FN of the frame data used for obtaining this, identification data CFID of the legally copied films, and identification data CID of the content linked together.

Log Conversion Unit 31:

The log conversion unit 31 logarithmically converts the object content reproduction signal RPCA obtained from the object film RF to generate the object content reproduction data RCT at step ST3 shown in FIG. 2.

Collation Unit 32:

The collation unit 32 collates the characteristic quantity data RRA of the object content reproduction signal RPCA and the characteristic quantity data CRA recorded in the database 15 and identifies the frame number data FN corresponding to the matching characteristic quantity data CRA and the identification data CID of the content.

Correlation Processing Unit 33:

The correlation processing unit 33 detects the correlation between the difference data DIF sequentially read from the database 25 and the object content reproduction data RCT input from the log conversion unit 31, decides whether or not there is any common point derived from the inherent variations in the recording sensitivity on the basis of the correlation data S33 indicating correlation, and identifies from which of the plurality of legally copied films CF the object film RF was obtained.

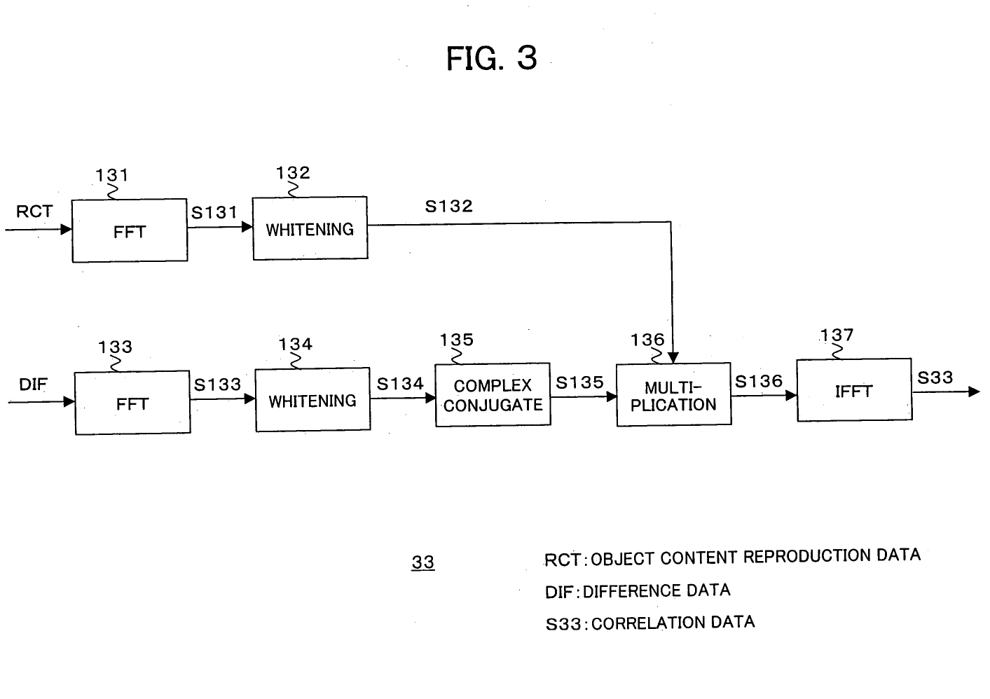

The correlation processing unit 33 detects correlation on the basis of the symmetrical phase only matched filtering (SPOMF) method. SPOMF is disclosed in “Symmetric Phase-Only Matched Filtering of Fourier-Mellin Transforms for Image Registration and Recognition”, IEEE Transaction on Pattern Analysis and Machine Intelligence, vol. 16, no. 12, December 1994 etc. FIG. 3 is a functional block diagram of the portion concerned with the correlation detection of the correlation processing unit 33 shown in FIG. 1. As shown in FIG. 3, the correlation processing unit 33 has, for example, an fast Fourier transform (FFT) circuit 131, a whitening circuit 132, an FFT circuit 133, a whitening circuit 134, a complex number conjugating circuit 135, a multiplier circuit 136, and an IFFT circuit 137.

The FFT circuit 131 applies for example a Fourier transform to the object content reproduction data RCT input from the log conversion unit 31 to generate first frequency component data S131 and outputs this to the whitening circuit 132. The whitening circuit 132 divides each complex number data forming the first frequency component data S131 by an absolute value of the complex number data (that is, making absolute values of the element data equal) to generate first complex number data S132 and outputs this to the multiplier circuit 136.

The FFT circuit 133 applies a Fourier transform to for example the difference data read from the database 25 to generate second frequency component data S133 and outputs this to the whitening circuit 134. The whitening circuit 134 divides each complex number data forming the second frequency component data S133 by the absolute value of the complex number data to generate second complex number data S134 and outputs this to the complex number conjugating circuit 135.

The complex number conjugating circuit 135 replaces each complex number data forming the second complex number data S134 by the complex conjugate complex number data to generates third complex number data S135 and outputs this to the multiplier circuit 136. The multiplier circuit 136 multiplies the first complex number data S132 and the third complex number data S135 to generate fourth complex number data S136 and outputs this to the IFFT circuit 137. The IFFT circuit 137 applies an inverse Fourier transform to the fourth complex number data S136 to generate the correlation data S33. Here, the correlation data indicates all values obtained by finding correlation by cyclically shifting the relative position between the difference data DIF and the object content reproduction data RCT in two dimensions.

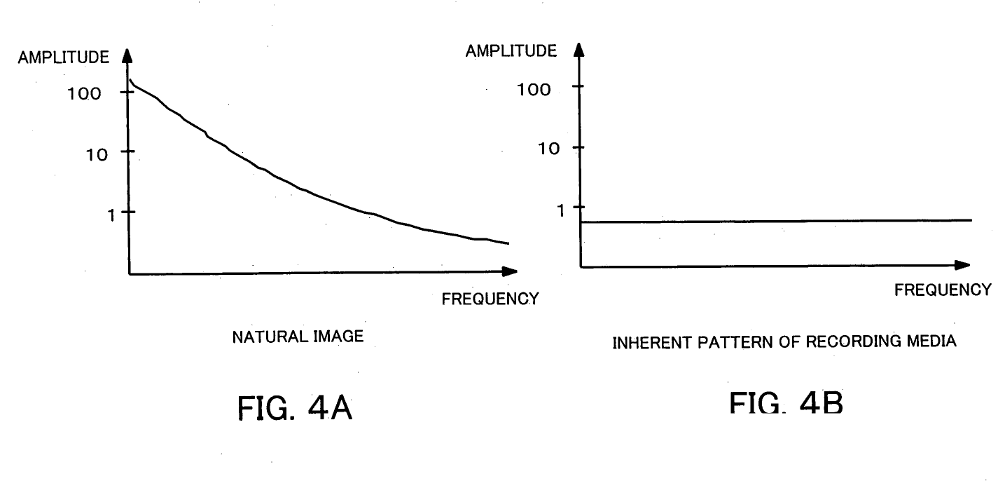

As shown in FIG. 4A, in a natural image, energy of the image is concentrated in the low frequency area. Contrary to this, the variations in recording sensitivity of recording media (films) are random phenomena, so the component superimposed on the image due to the variations in sensitivity has almost an equal energy over a broad frequency component as white noise as shown in FIG. 4B. By the collation by the SPOMF mentioned above, after the transform to the frequency domain, the absolute values of elements are made equal. For this reason, the collation of patterns of variations in recording sensitivity of recording media becomes possible without disturbance by the low frequency signal of a natural image.

For this reason, when an object film RF was not prepared on the basis of a legally copied film CF, the object content reproduction data RCT and the difference data DIF become uncorrelated. Namely, a large value is not generated at the origin of the correlation data S33. On the other hand, when the object film RF is prepared on the basis of a legally copied film CF, the object content reproduction data RCT and the difference data DIF are correlated due to the influence of the inherent recording sensitivity of the film. The correlation processing unit 33 decides that an object film RF was prepared on the basis of a legally copied film based on the correlation data S33 when the correlation value indicated by the correlation data S33 exceeds a predetermined value.

Below, an explanation will be given of the method of determining the value used for reference in the decision by the correlation processing unit 33. As mentioned above, the correlation data S33 shows all values obtained by finding correlation by cyclically shifting the relative position between the object content reproduction data RCT and the difference data DIF in two dimensions. Here, the object content reproduction data RCT and the difference data DIF are uncorrelated for a picture pattern etc., therefore values other than the origin of the correlation data S33 indicate accidental correlation values between uncorrelated data. The correlation processing unit 33 finds standard deviation a of the correlation data S33 and makes a decision using whether or not the value C00 of the origin of the correlation data S33 exceeds a predetermined multiple. The value C00 was used because, when correlation was found between the entire data, the inherent patterns of the recording sensitivity of the films matched in a state where the origins were made to match, so a peak appeared in the output C00 of the correlation in that case.

Each element data in the correlation data S33 is defined as Cij, while the number of the element data is defined as n. The correlation processing unit 33 generates a mean value “mean” of the values indicated by all element data in the correlation data S33 on the basis of the following equation (1):

cmean=(Σcij)/n (1)

Further, the correlation processing unit 33 generates the standard deviation a on the basis of the following equation (2) by using the mean value “mean”.

σ=√{{Σ(cij-cmean}×(cij-cmean)}/n} (2)

Then, the correlation processing unit 33 makes a decision on the basis of whether or not the value indicated by the element data c00 of the origin in the correlation data S33 exceeds 10 times (predetermined level) the standard deviation a on the basis of the following equation (3):

c00>10×σ (3)

As mentioned above, the correlation processing unit 33 decides which among the legally copied films CF the object film RF was prepared by finding the correlation between the object content reproduction data RCT and the difference data DIF by SPOMF. The probability of correctly making the decision can be quantified as follows. It can be considered that the result of the collation of the randomly distributed data follows a normal distribution. When detecting the correlation of the content data obtained from different films, it is decided that the two sets of data are not correlated. The probability of the value of correlation of uncorrelated data exceeding 10 σ is 7.6×10⁻²⁴.

Below, an explanation will be given of an example of operation of the data processor 1 shown in FIG. 1.

First Example of Operation:

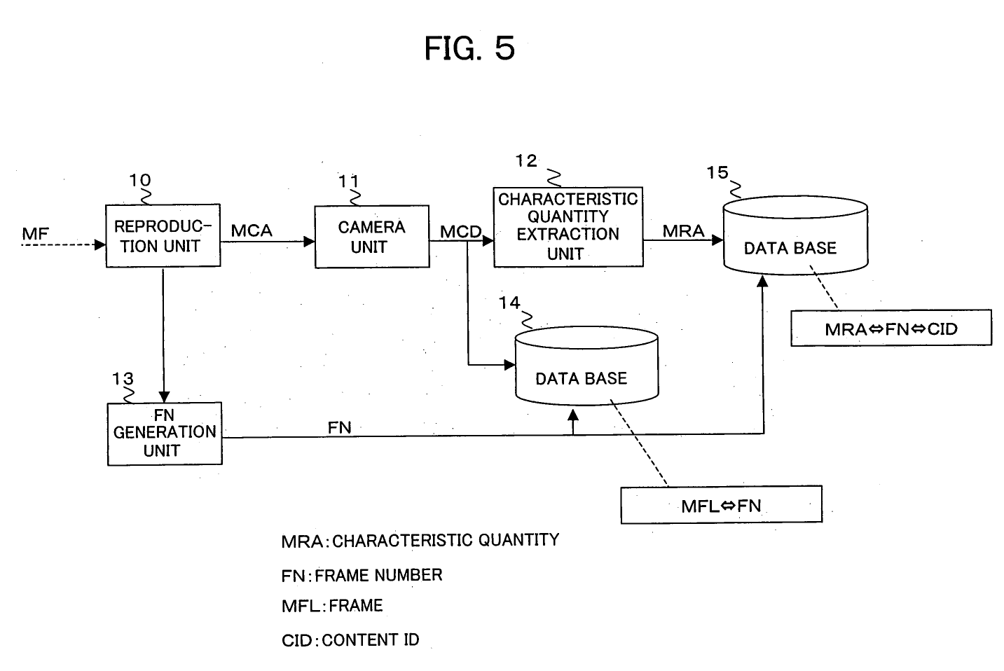

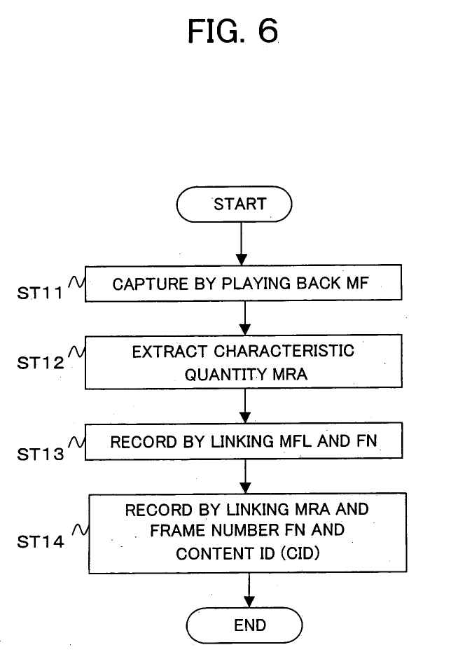

In this example of operation, an explanation will be given of the case of registering the master film MF (step ST1 shown in FIG. 2). FIG. 5 is a view for explaining the flow of the data in this example of operation; and FIG. 6 is a flow chart for explaining this example of operation. Below, an explanation will be given of the steps shown in FIG. 6 by referring to FIG. 5.

Step ST11:

The reproduction unit 10 plays back the master film MF, captures an image MCA thereof at the camera unit 11, and generates the digital master content data MCD.

Step ST12:

The characteristic quantity extraction unit 12 extracts the characteristic quantity of the master content data MCD and generates the characteristic quantity data MRA indicating the characteristic quantity.

Step ST13:

In parallel with the above operation, the FN generation unit 13 generates frame number data NF on the basis of the signal obtained in the playback operation of the film at the reproduction unit 10. Then, the frame MFL for which the characteristic quantity was extracted at step ST12 in the master content data MCD generated at step ST 11 and the frame number data FN from the FN generation unit 13 are recorded in the database 14 linked together.

Step ST14:

The characteristic quantity data MRA generated at step ST12, the frame number data FN corresponding to this, and the identification data (content ID) CID of the content of the master film MF are recorded in the database 15 linked together.

Second Example of Operation:

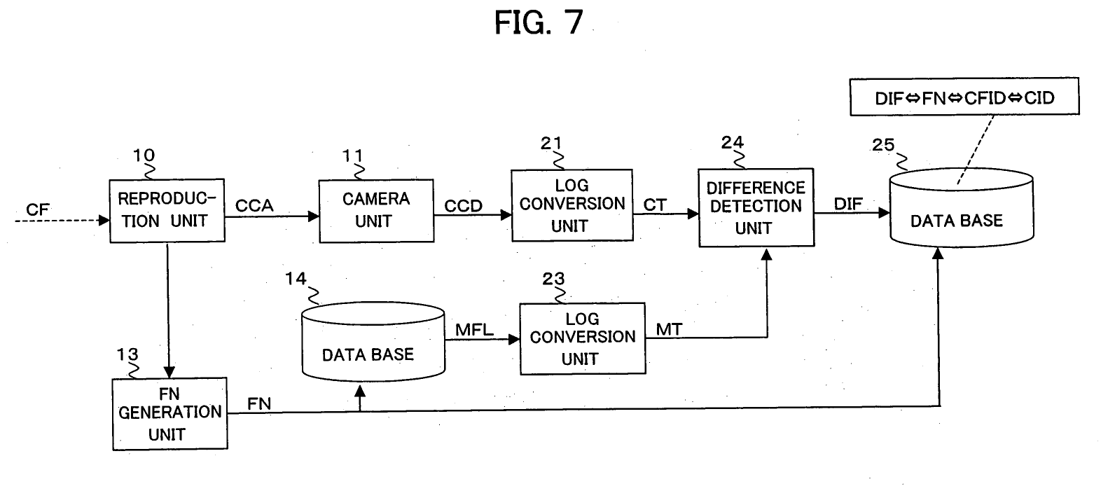

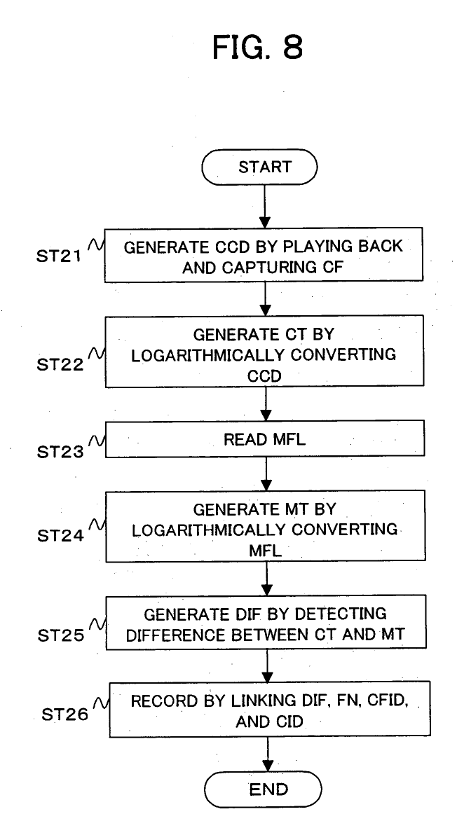

In this example of operation, an explanation will be given of a case of registering a legally copied film CF (step ST2 shown in FIG. 2). FIG. 7 is a view for explaining the flow of the data in this example of operation; and FIG. 8 is a flow chart for explaining this example of operation. Below, the steps shown in FIG. 8 will be explained by referring to FIG. 7. Note that the data processor 1 performs the following processing for all legally copied films CF prepared from the master film MF.

Step ST21:

The reproduction unit 10 plays back a legally copied film CF prepared from the master film MF, captures an image CCA thereof at the camera unit 11, and generates the digital copied content data CCD.

Step ST22:

The log conversion unit 21 logarithmically converts the copied (legally copied) content data CCD to generate the copied content data CT.

Step ST23:

The frame MFL of the master content data MCD is read from the database 14 and output to the log conversion unit 23.

Step ST24:

The log conversion unit 23 logarithmically converts the frame MFL input at step ST23 to generate the frame MT and outputs this to the difference detection unit 24.

Step ST25:

The difference detection unit 24 detects the difference data DIF indicating the difference between the copied content data CT generated at step ST22 and the frame MT input at step ST24.

Step ST26:

The database 25 records the difference data DIF obtained by the frame number corresponding to the frame MT linked together with the frame number data FN, the identification data CFID of the legally copied film, and the identification data CID of the content data on the basis of the frame number data FN from the FN generation unit 13.

Third Example of Operation:

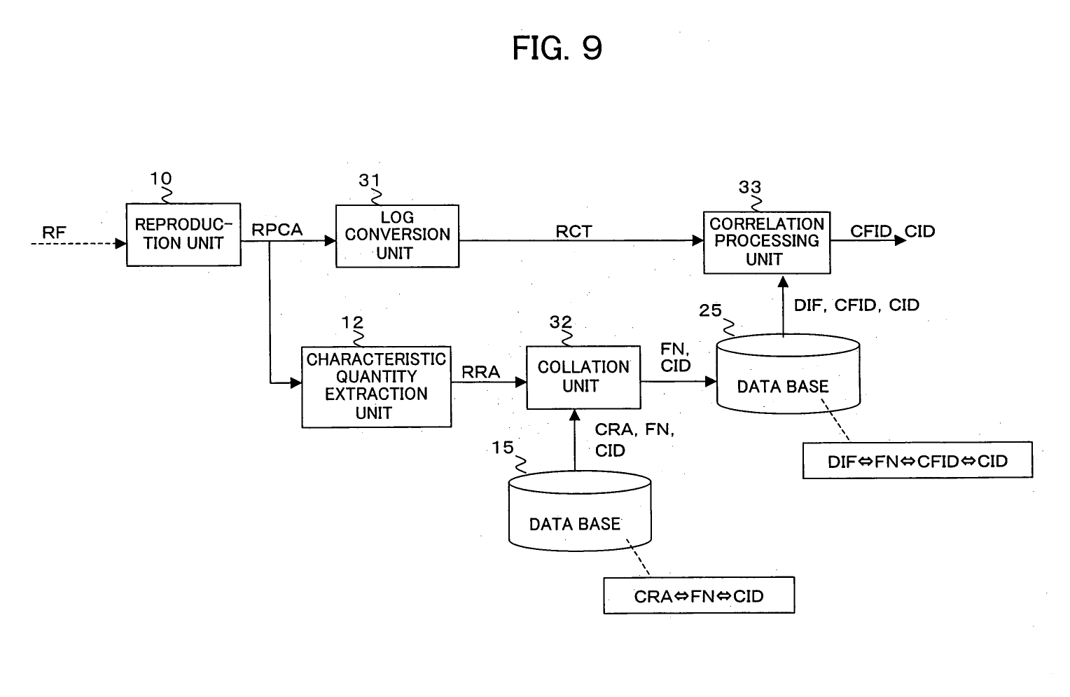

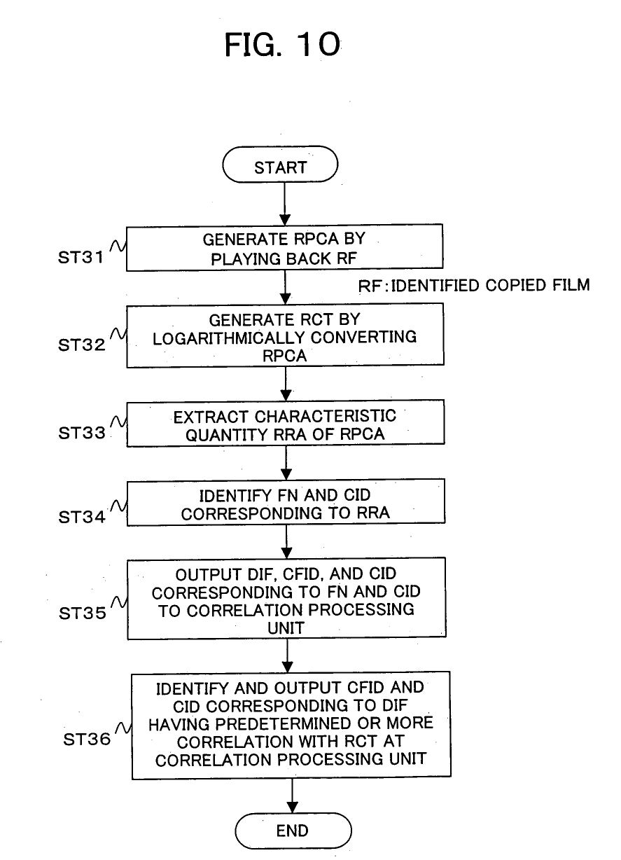

In this example of operation, an explanation will be given of a case of identifying the legally copied film CF which was the source of leakage of an object film RF (step ST3 shown in FIG. 2). FIG. 9 is a view for explaining the flow of the data in this example of operation; and FIG. 10 is a flow chart for explaining this example of operation. Below, an explanation will be given of the steps shown in FIG. 10 by referring to FIG. 9. Note that, in the present example of operation, a case of not capturing an image reproduced at the reproduction unit 10 by the camera unit 11 is illustrated, but it is also possible to capture an image at the camera unit 11, then output image to the characteristic quantity extraction unit 12 and the log conversion unit 31.

Step ST31:

The reproduction unit 10 plays back the object film RF and outputs the object content reproduction signal RPCA information to the log conversion unit 31 and the characteristic quantity extraction unit 12.

Step ST32:

The log conversion unit 31 logarithmically converts the object content reproduction signal RPCA to generate the object content reproduction data RCT and outputs this to the correlation processing unit 33.

Step ST33:

The characteristic quantity extraction unit 12 extracts the characteristic quantity of the object content reproduction signal RPCA and outputs the characteristic quantity data RRA indicating the characteristic quantity to the collation unit 32.

Step ST34:

The collation unit 32 identifies the characteristic quantity data CRA corresponding to the characteristic quantity data RRA input at step ST33 in the characteristic quantity data CRA stored in the database 15 and identifies the frame number data FN and the identification data CID of the content linked to the identified characteristic quantity data CRA.

Step ST35:

The collation unit 32 reads the difference data DIF corresponding to the frame number data FN and the identification data CID identified at step ST34 from the database 25 and outputs this to the correlation processing unit 33. The collation unit 32 sequentially outputs the plurality of difference data DIF obtained on the basis of the plurality of copied films to the correlation processing unit 33.

Step ST36:

The correlation processing unit 33 detects the correlation between the difference data DIF sequentially read from the database 25 at step ST35 and the object content reproduction data RCT input from the log conversion unit 31 at step ST32, decides whether or not there is any common point derived from inherent variations in the recording sensitivity on the basis of the correlation, and identifies from which of the plurality of legally copied films CF the object film RF was obtained. The correlation processing unit 33 outputs the identification data CFID of the legally copied film CF identified by this and the identification data CID of the content and makes a not illustrated display show the content according to need. Note that the identification data CFID of the legally copied film CF is linked with the identification data of the destination of distribution at for example the database 25, so it is also possible to further display the identification data of the destination of distribution on the display.

As explained above, according to the data processor 1, it can be identified from which among a plurality of legally copied films CF an object film RF was prepared. Further, the identification data CID of the content can be specified. By recording the destinations of distribution of legally copied films CF, when an object film RF is a pirated copy, it is possible to identify the destination of distribution involved in the preparation of the object film RF and take measures against copyright infringement.

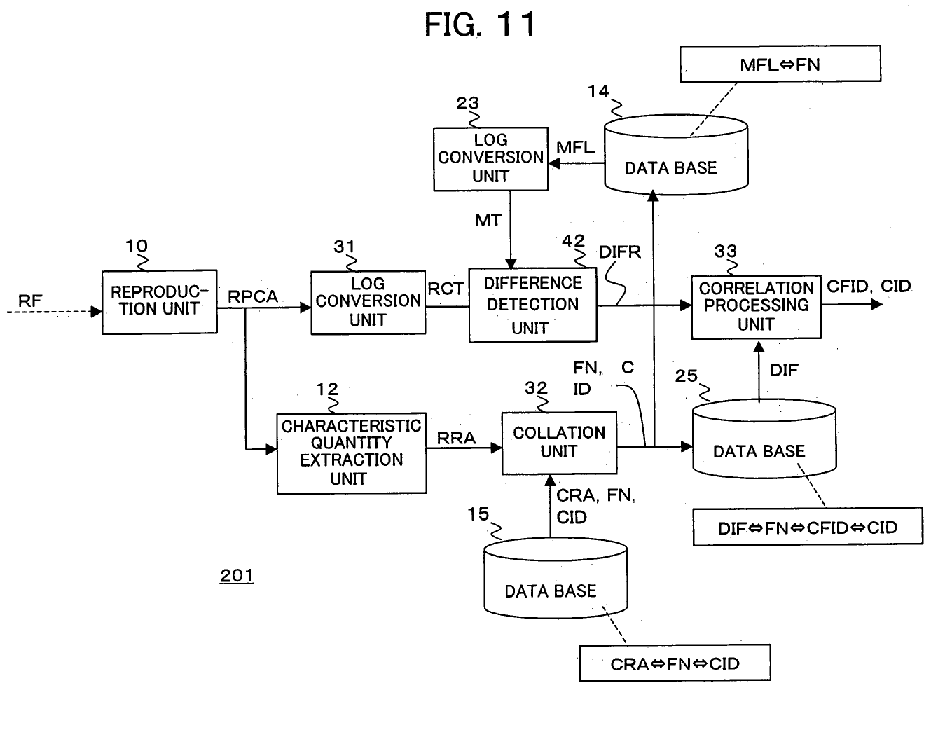

Second Embodiment In the first embodiment, as shown in FIG. 9, a case where the correlation processing unit 33 detected correlation between the object content reproduction data RCT from the log conversion unit 31 and the difference data DIF read from the database 25 was illustrated. FIG. 11 is a view for explaining a data processor 201 according to a second embodiment of the present invention. In the data processor 201 of the present embodiment, as shown in FIG. 11, the log conversion unit 23 logarithmically converts the frame data MFL of the master content read from the database 14 to generate the frame data MT. Then, the difference detection unit 42 generates the difference data DIFR indicating the difference between the object content reproduction data RCT and the frame data MT and outputs this to the correlation processing unit 33. Then, the correlation processing unit 33 detects the correlation between the difference data DIF and the difference data DIFR.

Effects the same as those by the data processor 1 of the first embodiment are also obtained by the data processor 201.

Third Embodiment

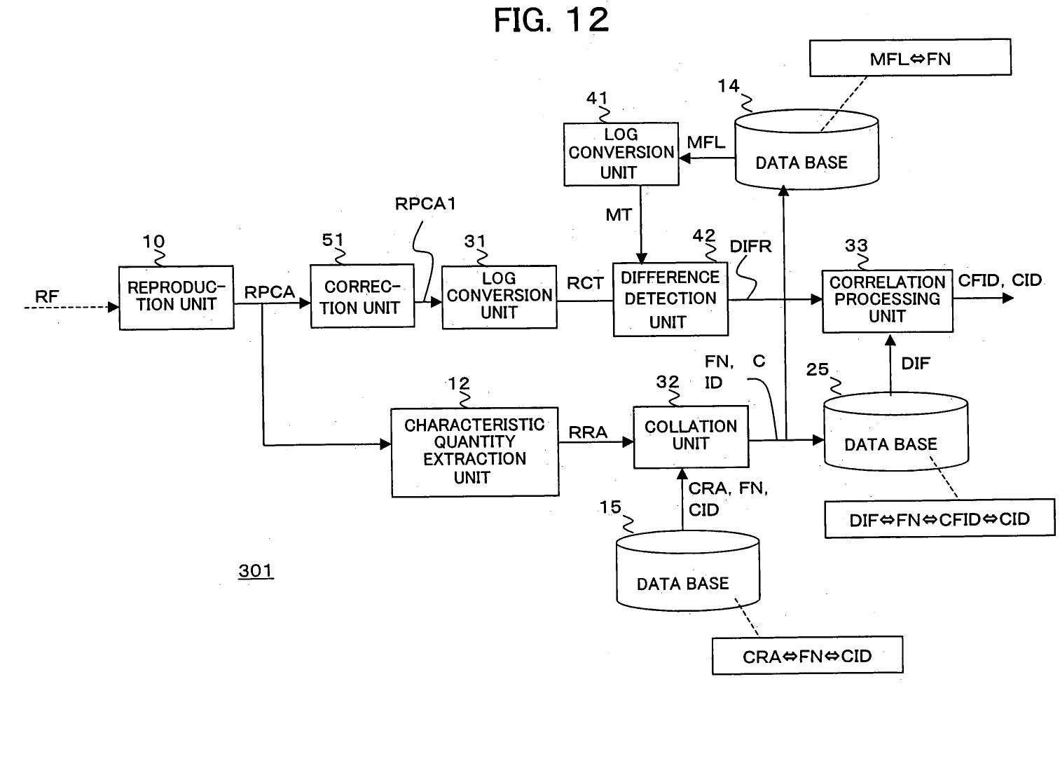

FIG. 12 is a view for explaining a data processor 301 according to a third embodiment of the present invention. As shown in FIG. 12, the data processor 301 is configured as the data processor 201 shown in FIG. 11 plus a correction unit 51 a the front of the log conversion unit 31. The correction unit 51 corrects distortion existing in the object content reproduction signal RPCA from the reproduction unit 10 to generate a new object content reproduction signal RPCA1 and outputs this to the log conversion unit 31. For example, when the object film RF is obtained by capturing the played back image of the copied film CF by using a camcorder or the like and recording the result, distortion is generated in the new object content reproduction signal RPCA. In the present embodiment, by correcting the distortion by the correction unit 51, the precision of the correlation detection by the later correlation processing unit 33 is raised. Note that the distortion mentioned above occurs where a geometric deformation is given to the identified content or compression, expansion, recording, reproduction, or the like is carried out for the data.

According to the data processor 301, from which among the plurality of legally copied films CF the object film RF was prepared can be identified with a high reliability.

The present invention is not limited to the above embodiments. For example, in the above embodiments, a film was illustrated as the recording medium of the present invention, but the recording medium of the present invention is not particularly limited so far as it is a recording medium having inherent variations in recording sensitivity which can be detected on the basis of the reproduction data. Further, in the above embodiments, the case where the object content reproduction data obtained from the object film RF was used was illustrated, but the third content data of the present invention may be data distributed via a network etc. too other than that obtained from a recording medium. Note that the first content data in the present invention does not always have to be obtained from a recording medium having inherent variations in recording sensitivity.

For example, several thousand copies of films for distribution for the use of movie theaters are prepared in a few days, so the speed becomes high (for example 100 times the showing speed). The usual telecine is difficult in actual circumstances at this speed. Accordingly, in the present embodiment, it is also possible to employ the technique of for example (1) extracting the noise of one or more noncontinuous frames, (2) obtaining shots of them by a two-dimensional imager, (3) creating in advance a loose portion in the film when the exposure time is not enough and stopping or slowing the speed of the corresponding frame portion for exactly the capture time, or (4) placing the camera for capturing the images on a rotary stand and matching the camera with the speed of the film. Further, it is also possible to employ the technique of reducing the number of pixels for every frame and using part of the screen or reducing the number of pixels by blurring by an optical filter or the like.

Further, in the present embodiment, the difference detection was carried out for the specified one frame data MFL, but it is also possible to use a plurality of difference data DIF generated for a plurality of frame data MFL.

Below, an explanation will be given of related art of the embodiments.

Electronic Distribution:

At present, distribution by film is the general practice, but distribution by digital recording on tapes, discs, hard discs, or other recording media and distribution via the network will probably increase in the future. In that case, a signal corresponding to the noise changed for every destination of distribution is inserted into the distribution use copied content. In this case, this signal can be controlled, so the amount of insertion and waveform can be controlled so that the collation can be reliably carried out while making it visually inconspicuous. In this case, it is also possible to record the signal corresponding to the noise as it is, but the recording capacity can be made smaller by recording the type or functions for generating this signal.

Video on Demand (VOD):

The invention can be applied for identifying a customer who illegally secondarily distributes content downloaded or streamed to a specified customer by VOD. The noise based on the customer number may be inserted into the output signal of the content. The same method can be used for music on demand (MOD), but sometimes simple random numbers would have a significant effect on the sound quality. Therefore, measures are taken aiming at a masking effect to make it inaudible. In the case of video as well, it is also possible to take measures for making the noise invisible.

Broadcast:

The invention can be applied to identification of the owner of a receiver illegally secondarily distributing broadcasted content by inserting noise formed based on a serial number identifying the receiver. In a pay broadcast receiver, the customer concludes a contract for conditional access, so if based on the contract number, the customer (illegal distributor) can be more reliably identified.

Package Media:

There is also a problem of secondary distribution from package media such as digital versatile disks (DVDs) or cassette videotapes. The same effects can be obtained by inserting noise based on a number identifying the apparatus in the same way as above.

Paper Media:

The same effects can be obtained by inserting noise based on a customer number for identifying a customer illegally secondarily distributing documents, photographs, sheets of music, and other copyrighted work output by paper. When the gradation is small, general noise will not work, so the noise is modulated by the position of the text etc. to obtain the same effects.

Bit Stream:

Sometimes content compressed by MPEG2 as prescribed in the IEEE1394 is output while compressed. It is necessary to consider a case of making copies and secondarily distributing them by this route. If inserting noise into the baseband signal as described above, the content will be output without superposition of the noise. Accordingly, preferably the noise is inserted in the bit stream. If the noise is inserted in the bit stream, the noise ends up being inserted in both outputs since the analog output is obtained by decompressing the bit stream. It has been known that noise can be inserted in the bit stream by operating the DCT coefficient so as not to change the code length.

Properties of Noise:

If assuming that it is possible to extract just the noise component by referring to the original text, the noise level can be made extremely small, but sometimes several measures are necessary if considering the case of noise disappearing for example due to compression, analog recording/reproduction, recapture, etc. First, it is preferable in view of tolerance if the noise level is raised, but the image quality (sound quality) would then deteriorate. To deal with this, it may be considered to insert a larger amount of noise at the portions of the content where the picture pattern is complex since it becomes hard to see there and to insert a smaller amount in the conspicuous flat portions. Assuming the noise is the same for every frame, the noise is not conspicuous in a still image, but the noise is conspicuous when the picture pattern moves. Accordingly, it the method may be considered of making the noise smaller in accordance with the movement of the picture pattern in portions where the picture pattern moves. Alternatively, a method may be considered of moving the noise matched with the picture pattern according to a certain predetermined rule. When the noise is the same for every frame, sometimes it is possible to extract just the noise by superimposing a large number of frames. It is possible to subtract the extracted noise from the content to eliminate the noise or to superimpose the noise from another party's content to disguise oneself as the other party. In order to cope with this, the noise is changed in a predetermined relationship with the components of the content.

Electronically prepared content has little noise in comparison with film. However, there are quite a few people who feel this to be unnatural since they are used to the noise of films. In actuality, there is an invention of an apparatus inserting noise resembling film (for example, the apparatus and method of generating a video disclosed in Japanese Unexamined Patent Publication (Kokai) No. 9-508507). It is considered that the noise should be as near the noise of film as possible. Accordingly, the method of extracting the noise by taking the difference at the time of copying film was explained. This method is truly the preferred method for generating noise. At this time, if the master film is a gray flat image, there is no longer intermixture of non-noise components. Namely, where the content is distributed not in the form of film, but in the form of electronic media, the noise for the collation (correlation detection) is inserted before distribution so that is becomes different for every destination of distribution. Further, when the content is distributed in the form of electronic media, the noise is inserted based on information related to the recipient by hardware or software at the reception side such as the content receiver or reception software.

Summarizing the effects of the invention, as explained above, according to the data processing method of the present invention and the apparatus of the same, it is possible to identify if third content data was obtained on the basis of a predetermined recording medium.

While the invention has been described with reference to specific embodiments chosen for purpose of illustration, it should be apparent that numerous modifications could be made thereto by those skilled in the art without departing from the basic concept and scope of the invention.

What is claimed is:

1. A data processing method for identifying whether or not a content data was obtained on the basis of a recording medium having inherent variations in recording sensitivity which is produced by recording a first content data, comprising:
a first step of detecting correlation between a difference between said first content data and second content data obtained from said recording medium and third content data which is an object for inspection and
a second step of deciding whether or not there is any common point derived from said inherent variations in said recording sensitivity between said second content data and said third content data on the basis of said correlation detected in said first step and identifying whether or not said third content data was obtained on the basis of said recording medium on the basis of a result of said decision.

2. A data processing method as set forth in claim 1, wherein said first step uses content data obtained from a predetermined recording medium as said first content data.

3. A data processing method as set forth in claim 1, wherein said first step detects correlation between said third content data obtained from a predetermined recording medium and said difference.

4. A data processing method as set forth in claim 1, wherein said first step detects correlation between said difference between said first content data and said second content data and a difference between said first content data and said third content.

5. A data processing method as set forth in claim 1, wherein:
said method further comprises a third step for extracting said difference and
said first step detects correlation between said difference extracted at said third step and said third content data.

6. A data processing method as set forth in claim 1, where:
said method further comprises:
a fourth step of capturing an image obtained from the predetermined recording medium to generate digital first content data;
a fifth step of capturing an image obtained from the recording medium having said inherent variations to generated digital second content data; and
a sixth step of capturing an image obtained from the recording medium which is the object for inspection to generate digital third content data, and
said first step detects correlation between a difference between said first content data generated at said fourth step and said second content data generated at said fifth step and said third content data generated at said sixth step.

7. A data processing method as set forth in claim 1, wherein:
said method further comprises:
a seventh step of extracting a predetermined characteristic quantity from said first content data and
an eighth step of extracting a predetermined characteristic quantity from said third content data, collating said extracted characteristic quantity and said characteristic quantity extracted at said seventh step, and identifying a part having said predetermined characteristic quantity extracted at said seventh step in said third content data, and
said first step detects correlation between said difference between said first content data at a part where said characteristic quantity is extracted at said seventh step and said second content data and a part identified by said eighth step in said third content data.

8. A data processing method as set forth in claim 1, wherein:
said method further comprises a ninth step of correcting distortion existing in said third content data and
said first step detects correlation between said difference and said third content data corrected at said ninth step.

9. A data processing method as set forth in claim 1, wherein said first step comprises:
a 10th step of applying an orthogonal transform to said difference and said third content data to generate said first frequency component data and second frequency component data,
an 11th step of dividing complex number data forming said first frequency component data by absolute values of the complex number data to generate first complex number data and dividing complex number data forming said second frequency component data by absolute values of the complex number data to generate second complex number data,
a 12th step of replacing complex number data forming one of said first complex number data and said second complex number data with conjugate complex number data to generate third complex number data,
a 13th step of multiplying said first complex number data or said second complex number data not replaced at said 12th step and said third complex number data generated at said 12th step to generate fourth complex number data, and
a 14th step of applying an inverse orthogonal transform to said fourth complex number data generated at said third step to detect said correlation.

10. A data processing apparatus for identifying whether or not a content data was obtained on the basis of a recording medium having inherent variations in recording sensitivity which is produced by recording a first content data, comprising:
a correlation detecting means for detecting correlation between a difference between said first content data and second content data obtained from said recording medium and third content data which is an object for inspection and
an identifying means for deciding whether or not there is any common point derived from said inherent variations in said recording sensitivity between said second content data and said third content data on the basis of said correlation detected by said correlation means and identifying whether or not said third content data was obtained on the basis of said recording medium on the basis of a result of said decision.

11. A data processing apparatus as set forth in claim 10, wherein said correlation detecting means detects correlation between said third content data obtained from a predetermined recording medium and said difference.

12. A data processing apparatus as set forth in claim 10, wherein said correlation detecting means detects correlation between said difference between said first content data and said second content data and the difference between said first content data and said third content.

13. A data processing apparatus for identifying whether or not a content data was obtained on the basis of a recording medium having inherent variations in recording sensitivity which is produced by recording a first content data, comprising:
a correlation detecting circuit for detecting correlation between a difference between said first content data and second content data obtained from said recording medium and third content data which is an object for inspection and
an identifying circuit for deciding whether or not there is any common point derived from said inherent variations in said recording sensitivity between said second content data and said third content data on the basis of said correlation detected by said correlation circuit and identifying whether or not said third content data was obtained on the basis of said recording medium on the basis of a result of said decision.
